(19) United States
(12) Patent Application Publication
(10) Pub. No.: US 2026/0197534 A1
(43) Pub. Date: Jul. 9, 2026

(54) METHOD AND SYSTEM FOR ENHANCING LIP SYNCHRONIZATION IN VIDEO GENERATION WITH NEW SPEECH

(71) Applicant: Constructor Technology AG, Schaffhausen (CH)

(72) Inventors: Sergey Ulasen, Singapore (SG); Andrey Adashchik, Istanbul (TR); Karsten Kozempel, Nürnberg (DE); Nwafor Chinedu Kenneth, Singapore (SG); Serg Bell, Singapore (SG); Stanislav Protasov, Singapore (SG); Nikolay Dobrovolskiy, Alanya (TR); Laurent Dedenis, Geneva (CH)

(21) Appl. No.: 19/008,834

(22) Filed: Jan. 3, 2025

(51) Int. Cl. H04N 21/81; G06T 5/73; G06T 11/60; G06T 13/20; G06V 10/24; G06V 40/16; G10L 13/02; H04N 5/265

(52) U.S. Cl. CPC H04N 21/816; G06T 5/73; G06T 11/60; G06T 13/205; G06V 10/245; G06V 40/171; G10L 13/02; H04N 5/265; G06T 2207/20084; G06T 2207/20132

(57) ABSTRACT

A method and system is disclosed for generating video content where speech audio is accurately synchronized with facial movements. The method begins by converting input text into speech audio using a text-to-speech (TTS) system. An original video is then processed to identify and extract the mouth area of the human face. The method generates a plurality of frames of the mouth area corresponding to segments of the speech audio using a trained generative neural network. These frames are lip-synced with the corresponding audio segments. The extracted mouth area frames are overlaid onto the original video, followed by performing facial reconstruction using a trained facial reconstruction model to correct distortions and achieve a natural and expressive appearance around the mouth area. Finally, the generated speech audio is combined with the modified video to produce a final video with synchronized lip movements and phonetic sounds.

### FIELD

The present disclosure relates to the field of video processing. More specifically, the present disclosure relates to a method and system for modifying existing videos by replacing the original speech with new speech, wherein the lip movements of the speakers in the video are precisely synchronized with the newly introduced speech audio.

### BACKGROUND

Video editing and enhancement have become integral to various applications, ranging from content creation to film restoration and dubbing. Traditionally, the focus has been on improving the visual quality, adding effects, or altering content. However, there is a growing demand for technologies that can modify speech in existing videos, particularly in applications like dubbing, translation, or content personalization.

Existing systems for speech replacement in videos often rely on simplistic approaches to lip-synchronization, such as manual editing or basic rule-based algorithms. While these systems may offer some level of lip-syncing, they often fall short in accurately replicating the complex nuances of human speech, leading to disjointed and unnatural animations of the speaker's mouth. Moreover, these systems may lack adaptability and robustness across different languages, accents, and speaking styles, limiting their effectiveness in diverse contexts.

One significant challenge in speech replacement in videos is achieving accurate lip-synchronization with the spoken words. Lip-synchronization is crucial for maintaining the naturalness and realism of the speaker's movements, ensuring that the video remains convincing and immersive. However, achieving precise lip-synchronization poses a formidable technical hurdle due to the complex articulatory dynamics of human speech.

There is therefore a need for advanced techniques and systems capable of achieving precise and dynamic lip-synchronization when replacing speech in existing videos. Addressing these challenges will not only enhance the realism and naturalness of the speaker's movements but also significantly improve the user experience in various applications such as dubbing, translation, and personalized content delivery.

Limitations and disadvantages of conventional and traditional approaches will become apparent to one of skill in the art, through comparison of described systems with some aspects of the present disclosure, as set forth in the remainder of the present application and with reference to the diagrams.

### SUMMARY

The present disclosure proposes a computer-implemented method and system for modifying existing videos to render new speech while ensuring accurate lip-synchronization with the original speaker's movements. To overcome the above deficiencies of the prior art, the present disclosure addresses the technical problems of improving the quality of video modifications, synchronizing the speaker's lips with new speech, correcting unnatural mouth shapes and movements, and performing facial reconstruction to maintain the natural appearance of the speaker.

According to an aspect, the present disclosure provides a computer-implemented method and system for generating a speech audio from an input text using a text-to-speech (TTS) system. The method and system include generating a speech audio from an input text using a TTS system and generating a plurality of frames (sequence of images) of the mouth area corresponding to the speech audio. The generation of these frames involves determining lip movements for each segment of the speech audio and performing facial reconstruction on the speaker's face using a trained facial reconstruction model for each frame of the original video.

The lip movements are generated using a trained generative neural network. The facial reconstruction corrects distortions and blurriness around the lips to achieve a natural and expressive facial representation. The method uses a trained generative neural network model to overlay the generated frames onto the original video, and the modified video is then combined with the new speech audio, creating a video where the speaker's lips are properly synchronized with the new speech audio.

The method and system further include training the discriminator model, which involves receiving an audio-video dataset where the speaker's lips are clearly visible during speech and separating the dataset into audio and video components. Audio features are extracted from the audio component as embeddings using a pretrained transformer model, encoding spectral features, phonetic characteristics, intonation patterns, speech rate, and articulation details to represent unique spoken word characteristics. A convolutional neural network (CNN) model is utilized to extract video features from the video component, capturing detailed lip contours, facial landmarks, and micro-expressions. The discriminator model is trained iteratively using the audio features and video features within a contrastive learning framework.

The method and system further include training the facial reconstruction model, which involves receiving a face image dataset capturing a user's lower face including clearly visible lips during speech. The dataset includes a plurality of facial images that serve as the base dataset for training the reconstruction neural network, providing rich variation and context for effective learning. The original facial image is modified by applying different image manipulating operations or artifacts. This includes, but is not limited to blur, noise, distortion, or region-based dropout (erasing pixels) to at least small regions or even the whole image. The modified facial image is fed into a reconstruction neural network. The reconstruction neural network tries to reconstruct and out the original facial image. A reconstruction loss is computed to update all learnable weights in the reconstruction neural network. The facial reconstruction model is trained iteratively using these captured facial movements within a contrastive learning framework to ensure that the reconstructed face appears natural and expressive in the modified video.

One or more advantages of the prior art are overcome, and additional advantages are provided through the disclosure. In addition to illustrative aspects, embodiments, and features described above, further aspects, embodiments, and features will become apparent by reference to drawings and following detailed description.

### BRIEF DESCRIPTION OF THE FIGURES

FIG. 1 is a diagram that illustrates a system for synchronizing new speech audio with lip movements in existing videos in accordance with an exemplary embodiment of the present disclosure.

FIG. 2 is a diagram that illustrates a block diagram of a generator training module in accordance with an embodiment of the present disclosure.

FIG. 3 is a diagram that illustrates a block diagram of a discriminator training module in accordance with an embodiment of the present disclosure.

FIG. 4 is a diagram that illustrates a block diagram of a facial reconstruction training module in accordance with an embodiment of the present disclosure.

FIG. 5 is a diagram that illustrates the flow chart for a method for synchronizing new speech audio with lip movements in an existing video in accordance with an embodiment of the present disclosure.

FIG. 6 is a diagram that illustrates a flow chart of a method for training a generator model in accordance with an embodiment of the present disclosure.

FIG. 7 is a diagram that illustrates a flow chart of a method for training a discriminator model in accordance with an embodiment of the present disclosure.

FIG. 8 is a diagram that illustrates a flow chart of a method for training a facial reconstruction model in accordance with an embodiment of the present disclosure.

### DETAILED DESCRIPTION OF THE INVENTION

Various embodiments of the present disclosure disclose a system and method for generating a video with synchronized speech by modifying an original video. The method and system receive an original video in which a human face is rendering speech. The original video is processed to extract the mouth area of the human face. Speech audio is generated from an input text using a text-to-speech (TTS) system. The method and system then generate a plurality of frames of the mouth area corresponding to a plurality of audio segments in the speech audio, with each frame's mouth area lip-synced to its corresponding audio segment using a trained generative neural network. The generated frames are overlaid onto the mouth area of the human face in the original video. Subsequently, facial reconstruction is performed on each frame of the original video using a trained facial reconstruction model, correcting distortions and blurriness around the mouth area to achieve a natural, sharp, and expressive facial representation. Finally, the speech audio is added to the modified video, resulting in a video where the speaker's lip movements are synchronized with the new speech audio.

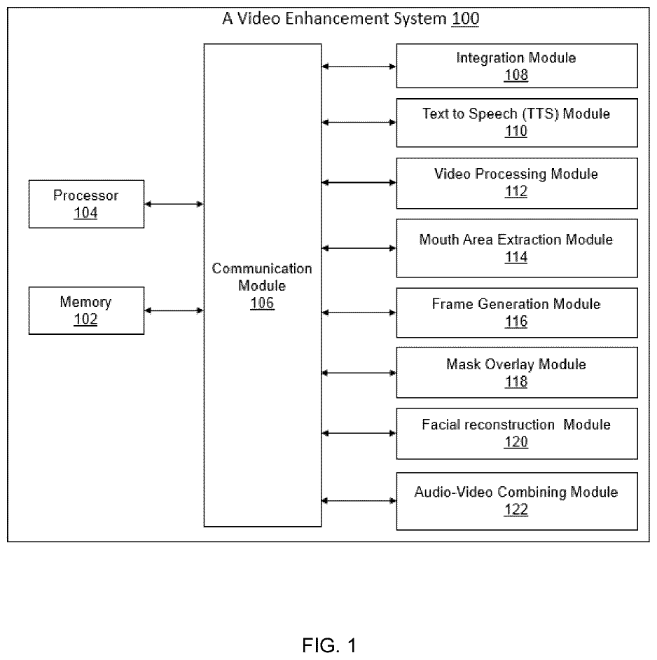

FIG. 1 is a diagram that illustrates a system for synchronizing new speech audio with lip movements in existing videos in accordance with an exemplary embodiment of the present disclosure.

As illustrated in FIG. 1, a video enhancement system 100 includes a memory 102, a processor 104, a communication module 106, an integration module 108, a text-to-speech (TTS) system 110, a video processing module 112, a mouth area extraction module 114, a frame generation module 116, a mask overlay module 118, a facial reconstruction module 120, and an audio-video combining module 122.

The memory 102 may comprise suitable logic, and/or interfaces, that may be configured to store instructions (for example, computer-readable program code) that can implement various aspects of the present disclosure.

The processor 104 may comprise suitable logic, interfaces, and/or code that may be configured to execute the instructions stored in the memory 102 to implement various functionalities of the video enhancement system 100 in accordance with various aspects of the present disclosure. The processor 104 may be further configured to communicate with various modules of the video enhancement system 100 via the communication module 106.

The communication module 106 may comprise suitable logic, interfaces, and/or code that may be configured to transmit data between modules, engines, databases, memories, and other components of the video enhancement system 100 for use in performing functions discussed herein. The communication module 106 may include one or more communication types and utilize various communication methods for communication within the video enhancement system 100.

The integration module 108 may comprise suitable logic, interfaces, and/or code that may be configured to receive both the input text and the original video from a data source. The text could be, but not limited to, plain text passages, sentences, or paragraphs sourced from written articles, transcripts of speeches or dialogues, social media posts, and web pages. The original video may depict a human face rendering speech. In another embodiment, the original video may depict a human face moving without uttering any words.

In an embodiment, the video enhancement system 100 is configured to translate the input text in multiple languages using a translation module (not shown in FIG. 1).

In an embodiment, the input text undergoes enrichment through the insertion of mark-ups, which denote a plurality of signs aimed at enhancing the audio output. These mark-ups encompass various elements such as emotion, word emphasis, sound volume, special articulation indicating specific lip movements and mouth shapes, and facial expressions. The utilization of mark-ups adds depth and nuance to the synthesized speech, enriching the overall communication experience.

In an embodiment, the mark-ups may be tailored to a specific speaker, reflecting their unique speaking style and mannerisms. This customization is achieved through a trained mark-up model, which learns to recognize and replicate the distinctive characteristics of individual speakers. Alternatively, the mark-ups may be generic across speakers, serving to enhance the clarity and expressiveness of the speech output universally. These mark-ups are generated by a trained mark-up model based on the input text, ensuring consistency and coherence in the synthesized audio.

In an embodiment, the input text received from the data sources undergoes quality assessment through a text quality checking module (not shown in FIG. 1). The text quality checking module analyzes the input text based on predefined quality metrics, evaluating aspects such as adherence to grammar rules, logical flow, comprehensibility, and linguistic sophistication. Through this comprehensive analysis, the text quality checking module generates a quality score that quantitatively represents the overall quality of the input text.

The quality score serves as a crucial decision-making tool, guiding the video enhancement system 100 in making informed decisions regarding the processing or treatment of the input text. These decisions may include adjusting parameters of the TTS module 110 to optimize speech synthesis performance, providing feedback to the text source for improvement, or selecting alternative text sources for speech synthesis to ensure high-quality output. By leveraging the insights provided by the quality score, the video enhancement system 100 enhances the effectiveness and fidelity of speech synthesis, delivering a superior audio-visual experience to users.

The TTS module 110 may comprise suitable logic, interfaces, and/or code that may be configured to receive the input text from the integration module 108. The TTS module 110 generates a speech audio from the input text. In an embodiment, the TTS module 110 is configured to generate a speech audio in multiple languages in accordance with the language of the input text.

The video processing module 112 may comprise suitable logic, interfaces, and/or code that may be configured to process the original video to extract a mouth area of the human face. This process includes aligning each frame of the original video based on the mouth position of the human face, recognizing the mouth area at each frame, and representing it as a mask. The video processing module 112 then crops an image of the mouth area according to the mask.

The mouth area extraction module 114 may comprise suitable logic, interfaces, and/or code that may be configured to perform the extraction of the mouth area from the processed video frames. The mouth area extraction module 114 generates a mask representing the mouth area and facilitates the identification and cropping of the mouth area image.

The frame generation module 116 may comprise suitable logic, interfaces, and/or code that may be configured to generate a plurality of frames of the mouth area corresponding to a plurality of audio segments in the speech audio. The mouth area in each frame is lip-synched with a corresponding audio segment of the plurality of audio segments using a trained generative neural network. The frame generation module 116 may utilize a combination of audio and visual encoders to align the lip movements with the phonetic sounds in the speech audio, generating frames that accurately reflect the mouth movements needed for lip-syncing.

The frame generation module 116 may comprise suitable logic, interfaces, and/or code that may be configured to generate a closed mouth in the extracted mouth area during the processing of the original video, particularly when no speech is detected or during pauses in the input audio. This closed mouth generation leverages a trained AI model, which has been optimized to ensure that frames corresponding to silent segments in the speech audio feature a naturally closed mouth expression.

The use of a closed mouth instead of retaining the original mouth configuration during these silent segments is advantageous for two reasons. First, the closed mouth frames facilitate improved lip-synchronization with the generated speech audio. The generative neural network operates by transforming each input frame to correspond to a respective audio segment. In instances where no speech audio is detected, the transformation effectively becomes an identity operation, retaining the input frame. If the original video frame includes an open mouth in these segments, this may result in an undesirable open mouth expression despite the absence of speech audio. By using a closed mouth in such instances, a more natural and visually coherent output is achieved.

Second, the generation of closed mouth frames aids in the alignment of the human face during the facial reconstruction process. The closed mouth serves as a stable reference point, allowing the trained facial reconstruction model to correct distortions and enhance the sharpness and expressiveness of the human face in each frame. This alignment ensures that the reconstructed face maintains a consistent and natural appearance across multiple frames, particularly in areas surrounding the mouth.

In particular, the frame generation module 116 is equipped with encoders designed for both audio and visual inputs, along with a video frame decoder utilizing these encodings. Audio encoding employs a sophisticated transformer neural network, pre-trained to extract essential phonetic features. Similarly, for the visual component, a convolutional neural network (CNN) is utilized to extract visual features such as colors, contours, edges, shapes, and other intricate details. This CNN may either be pre-trained or integrated within the module. Utilizing these audio-visual features, the module employs another CNN to integrate and learn joint audio-visual features, decoding them to generate corresponding visemes. These visemes represent distinct lip configurations associated with specific phonemes or speech sounds in the audio.

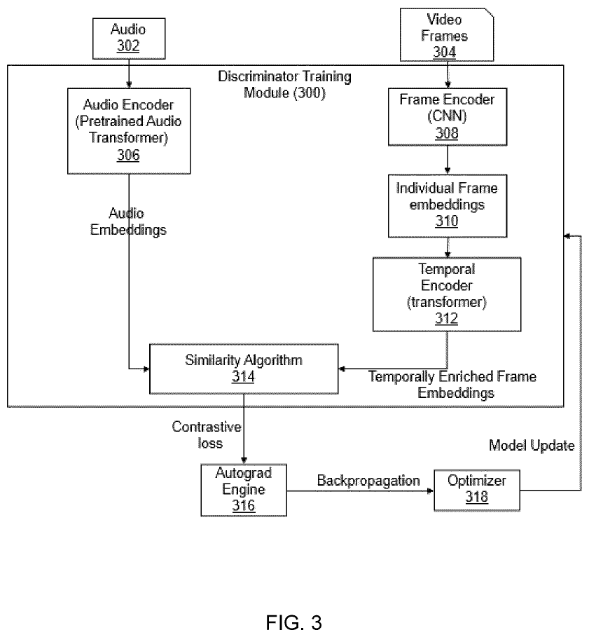

Furthermore, in an embodiment, the frame generation module 116 employes machine learning methodologies, such as deep learning, to refine and optimize the accuracy of lip movement prediction. Specifically, for training the frame generation module 116, a discriminator model may be utilized, which has been trained on a vast dataset comprising annotated speech audio samples and corresponding lip movement sequences. During the training process, the discriminator model learns to discern subtle correlations between acoustic features in the speech audio and visual cues in the corresponding lip movements. This enables the discriminator model to predict highly accurate lip movements for any given speech audio segment, even in the presence of variations in accent, intonation, and speech rate. The discriminator may also utilize a pretrained transformer model as well as a pretrained CNN model for prior feature extraction from the audio and video. The mechanism of training the discriminator model is elaborated upon in conjunction with FIG. 3.

The mask overlay module 118 may comprise suitable logic, interfaces, and/or code that may be configured to overlay the plurality of frames of the mouth area over the human face in the original video. This process integrates the generated mouth frames with the original video.

The facial reconstruction module 120 may comprise suitable logic, interfaces, and/or code that may be configured to perform facial reconstruction on the human face in each frame of the original video. The facial reconstruction is achieved using a trained facial reconstruction model in response to the overlaying of the plurality of frames of the mouth area over the human face in the original video. This reconstruction corrects distorted and blurry areas around the mouth area to achieve a natural, sharp, and expressive facial representation.

The facial reconstruction module 120 is designed to seamlessly integrate the lip movements determined by the frame generation module 116 onto the human face while ensuring natural and expressive facial representations.

In an embodiment, the facial reconstruction process involves the application of sophisticated image processing and computer vision methodologies to manipulate the facial geometry and texture dynamically. Leveraging state-of-the-art deep learning frameworks, such as contrastive learning frameworks, generative adversarial networks (GANs) or variational autoencoders (VAEs), the facial reconstruction module 120 learns complex mappings between speech audio features and facial deformations.

During reconstruction, the facial reconstruction module 120 selectively distorts facial areas around the lips, employing techniques such as mesh deformation or texture warping, to achieve lifelike lip movements synchronized with the speech audio. This distortion renders a natural and expressive facial expression, enhancing the realism and emotional impact of the speech rendering.

In an embodiment, the facial reconstruction module 120 employs the mark-ups inserted in the input text. By leveraging the information provided by these mark-ups, the facial reconstruction module 120 dynamically adjusts facial deformations to achieve natural and expressive facial representations that closely align with the intended emotional and linguistic nuances of the speech audio. Moreover, the mark-ups utilized by the facial reconstruction module 120 may be tailored to the specific characteristics of individual speakers, capturing their unique speaking styles and mannerisms. Through a trained mark-up model, the module learns to recognize and incorporate the distinctive features of each speaker into the facial reconstruction process, ensuring personalized and authentic speech rendering. Alternatively, the mark-ups may be designed to be generic across speakers, facilitating universal applicability and enhancing the clarity and expressiveness of the synthesized speech audio.

Moreover, the facial reconstruction module 120 employs real-time optimization algorithms to adaptively adjust facial deformations based on contextual cues from the speech audio. This dynamic adaptation enables the video to convey subtle nuances in speech articulation, including phonetic variations, emotional cues, and speaker characteristics.

The audio-video combining module 122 may comprise suitable logic, interfaces, and/or code that may be configured to combine the video with the overlaid mouth frames and the generated speech audio to create a video.

In an embodiment, the audio-video combining module 122 is configured to generate videos in multiple languages corresponding to the speech audio generated by the TTS module 110. This multi-language capability ensures that the videos effectively convey the intended message across diverse linguistic contexts. To achieve synchronization across languages, timing markups are incorporated into the input text, denoting specific frame points to be reached within a set time from an earlier frame point. This ensures temporal alignment of the videos in each language, maintaining coherence and continuity throughout the video sequence.

Moreover, when the input text corresponds to an original content with a specific time duration, the rendering of a generated video is adeptly adjusted to match the original time duration. This adjustment is achieved through various techniques, including slowing down the speech audio, inserting silent frames, or selectively removing sound portions, as necessary. By dynamically adapting the duration of the generated video, the video enhancement system 100 preserves the integrity of the original content while accommodating variations in speech rate and pacing across different languages. This ensures a seamless and synchronized audio-visual experience for viewers, regardless of the language in which the content is presented.

Further, by dynamically adjusting the timing and intensity of facial expressions, the video enhancement system 100 enhances the naturalism and expressiveness of the generated video, elevating communication, and engagement across diverse applications, including virtual assistants, educational platforms, and interactive media.

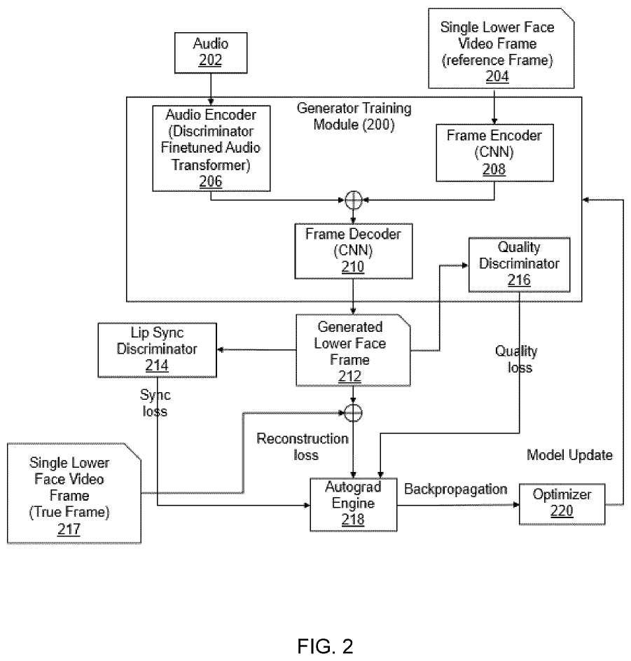

FIG. 2 is a diagram illustrating a block diagram of a generator training module 200 in accordance with an embodiment of the present disclosure. Referring to FIG. 2, shown are an audio dataset 202, a single lower face video frame 204, an audio encoder (Discriminator finetuned audio transformer) 206, a frame encoder (CNN) 208, a frame decoder 210, a generated lower face frame 212, a lip sync discriminator 214, a quality discriminator 216, an automatic differentiation (autograd) engine 218, a single lower face video frame (true frame) 217 and an optimizer 220.

The audio dataset 202 comprises a collection of audio frames or data samples utilized for training the generator module. Similarly, the single lower face video frame 204 is a reference frame while the true frame 217 consists of a video frame corresponding to the audio data, forming the visual component of the training dataset.

The audio encoder 206 processes the audio frames, extracting relevant features using a transformer neural network architecture. Conversely, the frame encoder (CNN) 208 processes the video frame, extracting visual features such as colors, shapes, and contours through a CNN architecture.

Outputs from the audio encoder 206 and the frame encoder (CNN) 208 are combined and fed into the frame decoder 210, another CNN. The frame decoder 210 produces a generated lower face frame 212 attempting to synchronize with the input video frame, effectively generating reconstructed frames.

This frame is designed to align with the provided audio data. The generated lower face frame 212 undergoes evaluation through several components: the lip sync discriminator 214 detects synchronization loss between the lip movements in the generated lower face frame 212 and the audio waveform, ensuring proper alignment; the quality discriminator 216 assesses the visual quality of the generated lower face frame 212, detecting any visual degradation or artifacts; and reconstruction loss is calculated by comparing the synthesized frame with the true frame 217, measuring the accuracy of the generated frame against the true frame.

To refine the generator module, the optimization process involves the autograd engine 218 and the optimizer 220 that backpropagate the synchronization loss, quality loss, and reconstruction loss. This iterative adjustment improves the accuracy and visual quality of the generated lower face frames, enhancing both lip-synchronization and overall visual fidelity. This method ensures that the generative neural network produces highly accurate and realistic lower face frames, contributing to a more expressive and natural representation of speech in video.

FIG. 3 is a diagram illustrating a block diagram of a discriminator training module 300 in accordance with an embodiment of the present disclosure. Referring to FIG. 3, the discriminator training module 300 includes an audio dataset 302, video frames 304, an audio encoder 306, a frame encoder 308, a temporal encoder 312, a similarity algorithm, an autograd engine 316 and an optimizer 318.

Referring to FIG. 3, the discriminator training module 300 is designed to train the discriminator for evaluating the synchronization and quality of generated video frames. The training process begins by providing an audio frame from the audio dataset 302 as input to the audio encoder 306, which comprises a pretrained audio transformer. This audio encoder extracts audio embeddings, capturing essential features from the audio frame that are critical for accurate synchronization with the visual data.

Simultaneously, the plurality of video frames 304 of the mouth area are provided as input to the frame encoder 308, which is equipped with a pretrained convolutional neural network (CNN) image encoder. This frame encoder extracts individual frame embeddings 310, representing the visual features of each video frame. These individual frame embeddings 310 are then fed into the temporal encoder 312, which utilizes a transformer to generate temporally enriched frame embeddings. This process captures the temporal relationships and dynamics between frames, enriching the visual information for better synchronization analysis.

The audio embeddings and the temporally enriched frame embeddings are then processed by the similarity algorithm 314 to compute a contrastive loss. This contrastive loss measures the difference between the audio and video embeddings, ensuring that the generated video frames are in proper alignment with the audio. The discriminator is optimized by backpropagating the contrastive loss through an autograd engine 316 and an optimizer 318. This optimization process updates the model parameters, enhancing the discriminator's ability to evaluate the quality and synchronization of the generated frames, and thus improving the overall performance of the system.

The optimizer 318 employs sophisticated optimization algorithms such as stochastic gradient descent (SGD) or Adam optimization to minimize the discrepancy between the predicted lip movements and ground truth annotations in the training dataset. Through backpropagation, the optimizer 318 fine-tunes the discriminator model parameters, enhancing its performance and generalization capabilities by minimizing training loss and maximizing model convergence.

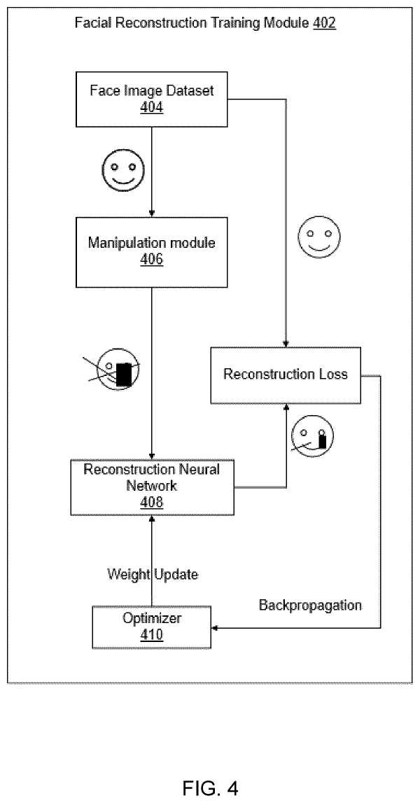

FIG. 4 is a block diagram illustrating the facial reconstruction training module 402 in accordance with an embodiment of the present disclosure. Referring to FIG. 4, the facial reconstruction training module 402 includes a face image dataset 404, a manipulation module 406, a reconstruction neural network 408 and an optimizer 410.

The face image dataset 404 includes a plurality of facial images, which can be extracted from videos. The facial images capture users with clear visibility of their lips during speech. These facial images serve as the base dataset for training the reconstruction neural network, providing rich variety of facial expressions for effective learning. In addition to the face image dataset 404, the facial reconstruction training module 402 is configured to access and integrate data from diverse external sources, expanding the breadth and diversity of the training dataset. By connecting to remote data sources, the facial reconstruction training module 402 enriches the training process with additional contextual information and variability, enhancing the robustness and generalization capabilities of the reconstruction neural network.

The manipulation module 406 modifies the original image, by applying different image manipulating operations or artifacts. This includes, but is not limited to blur, noise, distortion, or region-based dropout (erasing pixels) to at least small regions or even the whole image, which is shown on FIG. 4 as lines and black rectangles.

The reconstruction neural network gets at least one modified facial image as input and tries to create the original image as output. This can be performed by a typical convolutional encoder-decoder architecture like the UNet or other neural networks. An example of a face reconstruction neural network is the GFPGAN.

The difference between the original facial image and the reconstructed facial image is taken to compute the reconstruction loss. The optimizer 410 uses the reconstruction loss to compute the weight updates for the reconstruction neural network 408 to create better outputs, more like the original facial images.

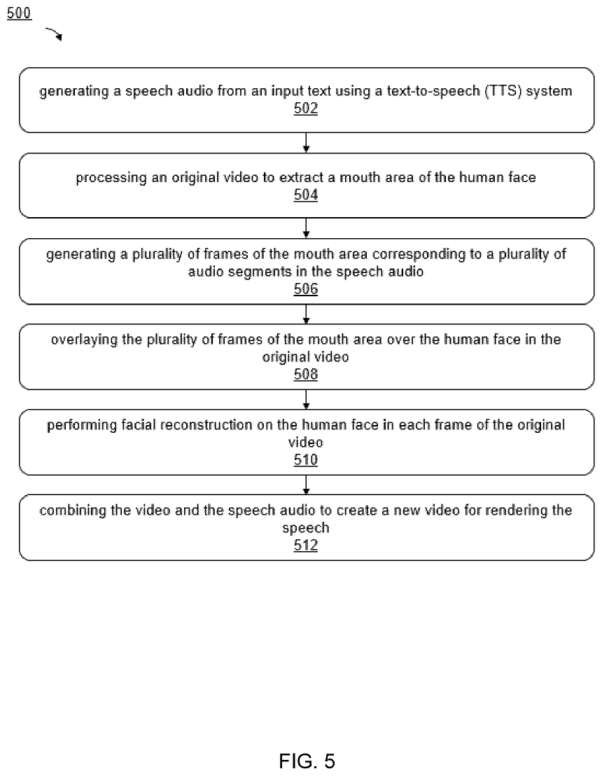

FIG. 5 is a diagram illustrating the flow chart for a method 500 for modifying an original video for rendering a different speech audio in accordance with an embodiment of the present disclosure.

At step 502, the method 500 generates a speech audio from an input text using the TTS module 110. The input text could be, but not limited to plain text passages, sentences, or paragraphs sourced from written articles, transcripts of speeches or dialogues, social media posts, and web pages.

In an embodiment, the video enhancement system 100 is configured to translate the input text into multiple languages using a translation module.

In an embodiment, the input text undergoes enrichment through the insertion of mark-ups, which denote a plurality of signs aimed at enhancing the audio output. These mark-ups encompass various elements such as emotion, word emphasis, sound volume, special articulation indicating specific lip movements and mouth shapes, and facial expressions. The utilization of mark-ups adds depth and nuance to the synthesized speech audio, enriching the overall communication experience.

In an embodiment, the mark-ups may be tailored to a specific speaker, reflecting their unique speaking style and mannerisms. This customization is achieved through a trained mark-up model, which learns to recognize and replicate the distinctive characteristics of individual speakers. Alternatively, the mark-ups may be generic across speakers, serving to enhance the clarity and expressiveness of the speech output universally. These mark-ups are generated by a trained mark-up model based on the input text, ensuring consistency and coherence in the synthesized audio.

In an embodiment, the input text undergoes quality assessment through a text quality checking module. The text quality checking module analyzes the input text based on predefined quality metrics, evaluating aspects such as adherence to grammar rules, logical flow, comprehensibility, and linguistic sophistication. Through this comprehensive analysis, the text quality checking module generates a quality score that quantitatively represents the overall quality of the input text.

The quality score serves as a crucial decision-making tool, guiding the video enhancement system 100 in making informed decisions regarding the processing or treatment of the input text. These decisions may include adjusting parameters of the TTS module 110 to optimize speech synthesis performance, providing feedback to the text source for improvement, or selecting alternative text sources for speech synthesis to ensure high-quality output. By leveraging the insights provided by the quality score, the video enhancement system 100 enhances the effectiveness and fidelity of speech synthesis, delivering a superior audio-visual experience to users.

At step 504, an original video is processed by the video processing module 112. This process includes aligning each frame of the original video based on the mouth position on the human face, recognizing the mouth area at each frame, and representing it as a mask. The module then crops an image of the mouth area according to the mask. Additionally, during the processing, a closed mouth is generated in the mouth area. This can be done using a trained AI model or simply projecting a closed mouth cut from a reference frame to each frame in the video. The generation of a closed mouth ensures improved lip-synchronization during subsequent steps and aids in aligning the face to predefined orientations for enhanced facial reconstruction and in-painting.

At step 506, the method 500 generates a plurality of frames of the mouth area corresponding to a plurality of audio segments in the speech audio. The mouth area in each frame is lip-synched with a corresponding audio segment of the plurality of audio segments using the trained generative neural network.

At step 508, the method 500 overlays the plurality of frames of the mouth area over the human face in the original video. This process integrates the generated mouth frames with the original video.

At step 510, the method 500 performs facial reconstruction on the human face in each frame of the original video. The facial reconstruction is achieved using a trained facial reconstruction model in response to the overlaying of the plurality of frames of the mouth area over the human face in the original video. This reconstruction corrects distorted and blurry areas around the mouth area to achieve a natural, sharp, and expressive facial representation.

In an embodiment, the facial reconstruction process involves the application of sophisticated image processing and computer vision methodologies to manipulate the facial geometry and texture dynamically. Leveraging state-of-the-art deep learning frameworks, such as generative adversarial networks (GANs) or variational autoencoders (VAEs), the facial reconstruction module 120 learns complex mappings between speech audio features and facial deformations.

During reconstruction, the facial reconstruction module 120 selectively distorts facial areas around the lips, employing techniques such as mesh deformation or texture warping, to achieve lifelike lip movements synchronized with the speech audio. This distortion renders a natural and expressive facial expression, enhancing the realism and emotional impact of the video's speech rendering.

In an embodiment, the facial reconstruction module 120 employs the mark-ups inserted in the input text. By leveraging the information provided by these mark-ups, the facial reconstruction module 120 dynamically adjusts facial deformations to achieve natural and expressive facial representations that closely align with the intended emotional and linguistic nuances of the speech audio. Moreover, the mark-ups utilized by the facial reconstruction module 120 may be tailored to the specific characteristics of individual speakers, capturing their unique speaking styles and mannerisms. Through a trained mark-up model, the module learns to recognize and incorporate the distinctive features of each speaker into the facial reconstruction process, ensuring personalized and authentic videos. Alternatively, the mark-ups may be designed to be generic across speakers, facilitating universal applicability and enhancing the clarity and expressiveness of the synthesized speech audio.

At step 512, the method 500 combines the video with the overlaid mouth frames and the generated speech audio to create a new video rendering the speech. In accordance with various embodiments of the present disclosure, the mouth area's lip movements are coordinated with the phonetic sounds uttered in the speech audio.

Moreover, when the input text corresponds to an original content with a specific time duration, the rendering of a generated video is adeptly adjusted to match the original time duration. This adjustment is achieved through various techniques, including slowing down the speech audio, inserting silent frames, or selectively removing sound portions, as necessary. By dynamically adapting the duration of the generated video, the video enhancement system 100 preserves the integrity of the original content while accommodating variations in speech rate and pacing across different languages. This ensures a seamless and synchronized audio-visual experience for viewers, regardless of the language in which the content is presented.

Further, by dynamically adjusting the timing and intensity of facial expressions, the video enhancement system 100 enhances the naturalism and expressiveness of the generated video, elevating communication, and engagement across diverse applications, including virtual assistants, educational platforms, and interactive media.

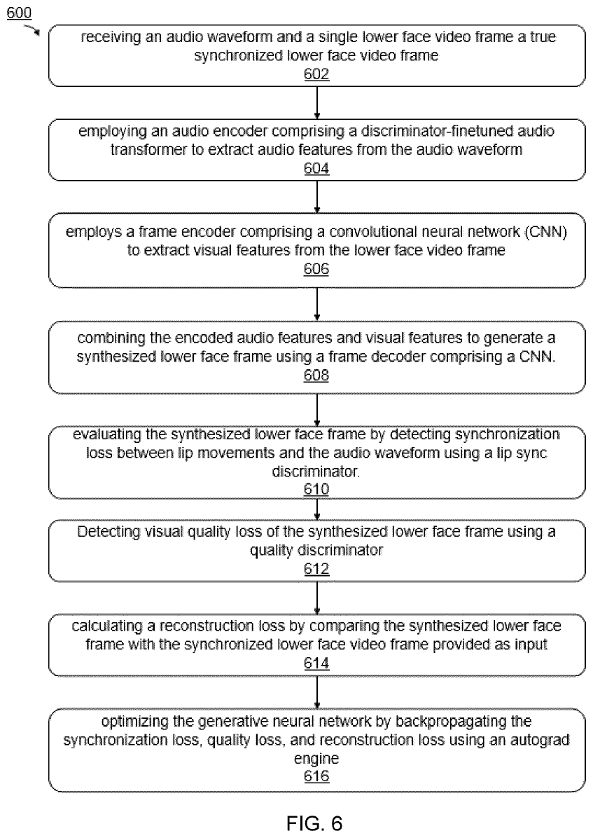

FIG. 6 is a diagram illustrating a flow chart of a method 600 for training a generator model in accordance with an embodiment of the present disclosure.

At step 602, the method 600 receives an audio waveform, a single lower face video frame and a true synchronized lower face video frame.

At step 604, the method 600 employs an audio encoder comprising a discriminator-finetuned audio transformer to extract audio features from the audio waveform.

At step 606, the method 600 employs a frame encoder comprising a convolutional neural network (CNN) to extract visual features from the lower face video frame.

At step 608, the method 600 combines the encoded audio features and visual features to generate a synthesized lower face frame using a frame decoder comprising a CNN.

At step 610, the method 600 evaluates the synthesized lower face frame by detecting synchronization loss between lip movements and the audio waveform using a lip-synched discriminator.

At step 612, the method 600 detects visual quality loss of the synthesized lower face frame using a quality discriminator.

At step 614, the method 600 calculates a reconstruction loss by comparing the synthesized lower face frame with the synchronized lower face video frame provided as input.

At step 616, the method 600 optimizes the generative neural network by backpropagating the synchronization loss, quality loss, and reconstruction loss using an autograd engine, thereby improving the accuracy and visual quality of the generated lower face frames in synchronization with the audio input.

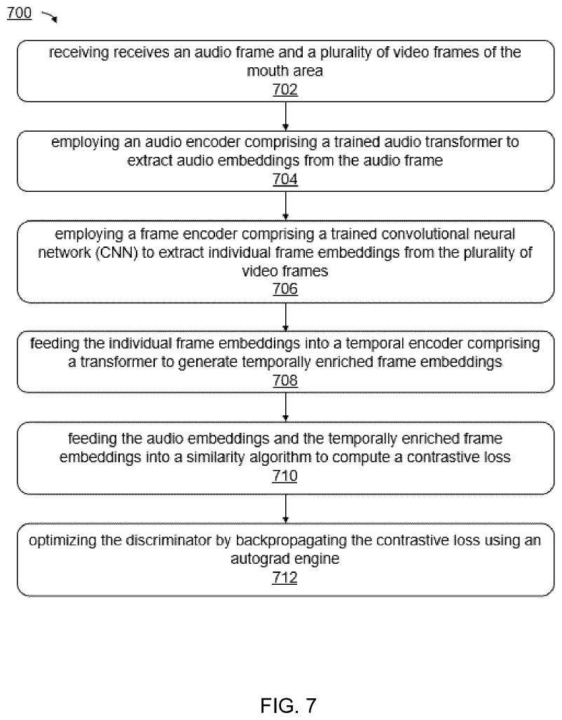

FIG. 7 is a diagram illustrating a flow chart of a method 700 for training a discriminator model in accordance with an embodiment of the present disclosure.

At step 702, the method 700 receives an audio frame and a plurality of video frames of the mouth area.

At step 704, the method 700 employs an audio encoder comprising a trained audio transformer to extract audio embeddings from the audio frame.

At step 706, the method 700 employs a frame encoder comprising a trained convolutional neural network (CNN) to extract individual frame embeddings from the plurality of video frames.

At step 708, the method 700 feeds the individual frame embeddings into a temporal encoder comprising a transformer to generate temporally enriched frame embeddings.

At step 710, the method 700 feeds the audio embeddings and the temporally enriched frame embeddings into a similarity algorithm to compute a contrastive loss.

At step 712, the method 700 optimizes the discriminator by backpropagating the contrastive loss using an autograd engine, thereby updating the model parameters.

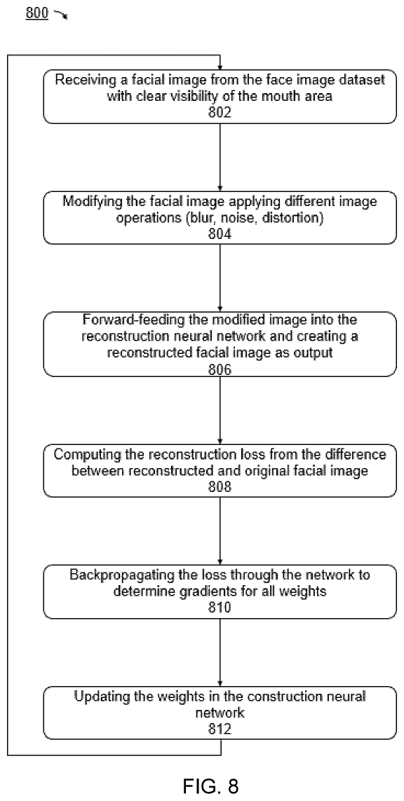

FIG. 8 is a diagram illustrating a flow chart of method 800 for training a facial reconstruction model in accordance with an embodiment of the present disclosure.

At step 802, the method 800 receives a face image dataset capturing a user's lower face including clearly visible lips during speech. The dataset includes a plurality of facial images that serve as the base dataset for training the reconstruction neural network, providing rich variation and context for effective learning.

At step 804, the method 800 modifies the original image, by applying different image manipulating operations or artifacts. This includes, but is not limited to blur, noise, distortion, or region-based dropout (erasing pixels) to at least small regions or even the whole image, which is shown on FIG. 4 as lines and black rectangles.

At step 806, the method 800 feeds the modified facial image into a reconstruction neural network 408 (such as CNN). The reconstruction neural network tries to reconstruct the original facial image.

At step 808, the method 800 computes a reconstruction loss, which is a difference between the reconstructed and the original facial image.

At step 810, the method 800 uses backpropagation to feed the reconstruction loss back through the network to get gradients for every weight.

At step 812, the method 800 uses the optimizer, such as Stochastic Gradient Descent (SGD) or ADAM to update all learnable weights in the reconstruction neural network 408. Then, the process returns to step 802 until the training ends.

The method and system are advantageous in that they leverage advanced machine learning techniques and neural network architecture to generate videos where speech audio is accurately synchronized with lip movements and facial expressions. By mapping audio inputs to naturalistic lip movements and facial expressions, the method and system produce lifelike video renderings that closely mimic human speech patterns and non-verbal cues, enhancing user engagement and immersion.

Another advantage of the method and system is that they offer extensive customization options, allowing for the generation of videos tailored to specific user needs and preferences. Through precise alignment of audio with facial movements and expressions, the method and system create video content that reflects the unique characteristics and requirements of different use cases, fostering deeper connections and engagement in various interactive applications.

Yet another advantage of the method and system is that they support multiple languages and dialects, catering to diverse linguistic audiences. The method and system enable seamless communication and interaction across global markets by dynamically adjusting video content based on the language of the input text, ensuring culturally sensitive and contextually appropriate speech synthesis.

The method and system are also advantageous in that they continuously evolve and improve over time, enhancing performance and capabilities in response to user feedback and changing conditions. By leveraging real-time data analytics and user interactions, the system iteratively refines its models and algorithms, delivering increasingly sophisticated and immersive video experiences that meet and exceed user expectations.

Those skilled in the art will realize that the above-recognized advantages and other advantages described herein are merely exemplary and are not meant to be a complete rendering of all of the advantages of the various embodiments of the present invention.

In the foregoing specification, specific embodiments of the present disclosure have been described. However, one of the ordinary skills in the art appreciates that various modifications and changes can be made without departing from the scope of the present disclosure. Accordingly, the specification and figures are to be regarded in an illustrative rather than a restrictive sense, and all such modifications are intended to be included within the scope of the present disclosure.

What is claimed is:

1. A computer-implemented method for generating a video for rendering speech, the method comprising:
receiving an original video, wherein the original video comprises a human face rendering a speech;
processing the original video to extract a mouth area of the human face;
generating a speech audio from an input text using a text-to-speech (TTS) system;
generating a plurality of frames of the mouth area corresponding to a plurality of audio segments in the speech audio, wherein the mouth area in each frame is lip-synched with a corresponding audio segment of the plurality of audio segments in the speech audio using a pre-trained generative neural network;
overlaying the plurality of frames of the mouth area over the human face in the original video;
performing facial reconstruction of the human face in each frame of the original video using a trained facial reconstruction model in response to the overlaying, wherein the facial reconstruction corrects distorted and blurry areas around the mouth area to achieve a natural, sharp, and expressive facial representation; and
adding the speech audio to the original video in response to performing the facial reconstruction for generating the video for rendering speech.

2. The method of claim 1, wherein the processing of the original video comprises:
aligning each frame of the original video based on detected mouth position of the human face;
recognizing the mouth area of the human face at each frame of the original video and representing the mouth area as a mask; and
cropping an image of the mouth area according to the mask.

3. The method of claim 2, wherein during the processing of the original video, a closed mouth is generated in the mouth area using a trained AI model.

4. The method of claim 1, wherein training of the generative neural network comprises:
providing an audio waveform as input to an audio encoder, the audio encoder comprising a discriminator-finetuned audio transformer for extracting audio features;
providing a lower face video frame as input to a frame encoder, the frame encoder comprising a convolutional neural network (CNN) for extracting visual features of the mouth area;
combining the encoded audio features and visual features to generate a synthesized lower face frame using a frame decoder comprising a CNN;
evaluating the synthesized lower face frame by:
detecting synchronization loss between lip movements and the audio waveform using a lip sync discriminator;
detecting visual quality loss of the synthesized lower face frame using a quality discriminator;
calculating a reconstruction loss by comparing the synthesized lower face frame with the lower face video frame provided as input; and
optimizing the generative neural network by backpropagating the synchronization loss, quality loss, and reconstruction loss using an autograd engine, thereby improving the accuracy and visual quality of the generated lower face frames in synchronization with the audio input.

5. The method of claim 1, wherein training of the discriminator module comprises:
providing an audio frame as input to an audio encoder, the audio encoder comprising a pretrained audio transformer for extracting audio embeddings;
providing a plurality of video frames of the mouth area as input to a frame encoder, the frame encoder comprising a pretrained convolutional neural network (CNN) image encoder for extracting individual frame embeddings;
feeding the individual frame embeddings into a temporal encoder comprising a transformer for generating temporally enriched frame embeddings;
feeding the audio embeddings and the temporally enriched frame embeddings into a similarity algorithm for computing a contrastive loss; and
optimizing the discriminator by backpropagating the contrastive loss using an autograd engine to update model parameters.

6. The method of claim 1, wherein training of the facial reconstruction model comprises:
receiving a face image dataset capturing the user with clear visibility of lips during speech;
modifying an original facial image using one or more image manipulating operations and artifacts to obtain one or more modified facial images;
utilizing a reconstruction neural network to generate the original image with at least one modified facial image as input;
computing a reconstruction loss; and
updating weights for the reconstruction neural network based on the reconstruction loss.

7. The method of claim 1, wherein the input text is enriched with mark-ups denoting a plurality of signs, wherein the plurality of signs comprises emotion, word emphasis, sound volume and special articulation indicating specific lip movements and shape of mouth, and facial expressions, wherein the mark-ups are employed by the facial reconstruction model.

8. The method of claim 1, wherein the mark-ups are specific to a speaker, wherein the mark-ups are generated by a trained mark-up model, the mark-up model being trained to recognize and replicate a speaking style of a speaker.

9. The method of claim 1, wherein the mark-ups are generic across speakers, wherein the mark-ups are generated by a trained mark-up model based on the input text.

10. A computer system comprising a processor and one or more computer readable storage media, and program instructions collectively stored on the one or more computer readable storage media, the program instructions executable by the processor to cause the processor to perform operations comprising:
receiving an original video, wherein the original video comprises a human face rendering a speech;
processing the original video to extract a mouth area of the human face;
generating a speech audio from an input text using a text-to-speech (TTS) system;
generating a plurality of frames of the mouth area corresponding to a plurality of audio segments in the speech audio, wherein the mouth area in each frame is lip-synched with a corresponding audio segment of the plurality of audio segments in the speech audio using a pre-trained generative neural network;
overlaying the plurality of frames of the mouth area over the human face in the original video;
performing facial reconstruction of the human face in each frame of the original video using a trained facial reconstruction model in response to the overlaying, wherein the facial reconstruction corrects distorted and blurry areas around the mouth area to achieve a natural, sharp, and expressive facial representation; and
adding the speech audio to the original video in response to performing the facial reconstruction for generating the video for rendering speech.

11. The computer system of claim 10, wherein the processing of the original video comprises:
aligning each frame of the original video considering the mouth position of the human face;
recognizing the mouth area of the human face at each frame of the original video and representing the mouth area as a mask; and
cropping an image of the mouth area according to the mask.

12. The computer system of claim 11, wherein a closed mouth is generated in the mouth area using a trained AI model.

13. The computer system of claim 10, wherein training of the generative neural network comprises:
providing an audio waveform as input to an audio encoder, the audio encoder comprising a discriminator-finetuned audio transformer for extracting audio features;
providing a lower face video frame as input to a frame encoder, the frame encoder comprising a convolutional neural network (CNN) for extracting visual features of the mouth area;
combining the encoded audio features and visual features to generate a synthesized lower face frame using a frame decoder comprising a CNN;
evaluating the synthesized lower face frame by:
detecting synchronization loss between lip movements and the audio waveform using a lip sync discriminator;
detecting visual quality loss of the synthesized lower face frame using a quality discriminator;
calculating a reconstruction loss by comparing the synthesized lower face frame with the lower face video frame provided as input; and
optimizing the generative neural network by backpropagating the synchronization loss, quality loss, and reconstruction loss using an autograd engine, thereby improving the accuracy and visual quality of the generated lower face frames in synchronization with the audio input.

14. The computer system of claim 10, wherein training of the discriminator module comprises:
providing an audio frame as input to an audio encoder, the audio encoder comprising a pretrained audio transformer for extracting audio embeddings;
providing a plurality of video frames of the mouth area as input to a frame encoder, the frame encoder comprising a pretrained convolutional neural network (CNN) image encoder for extracting individual frame embeddings;
feeding the individual frame embeddings into a temporal encoder comprising a transformer for generating temporally enriched frame embeddings;
feeding the audio embeddings and the temporally enriched frame embeddings into a similarity algorithm for computing a contrastive loss; and
optimizing the discriminator by backpropagating the contrastive loss using an autograd engine to update model parameters.

15. The computer system of claim 10, wherein training of the facial reconstruction model comprises:
receiving a face image dataset capturing the user with clear visibility of lips during speech;
modifying an original facial image using one or more image manipulating operations and artifacts to obtain one or more modified facial images;
utilizing a reconstruction neural network to generate the original image with at least one modified facial image as input;
computing a reconstruction loss; and
updating weights for the reconstruction neural network based on the reconstruction loss.
